(19) United States
(12) Patent Application Publication
(10) Pub. No.: US 2008/0038835 A1
(43) Pub. Date: Feb. 14, 2008

(54) Reference Member for Fluorescence Measurements, and Method for the Production Thereof

(76) Inventors: Peter Westphal, Jena (DE); Daniel Bublitz, Jena (DE)

Correspondence Address: JACOBSON HOLMAN PLLC, 400 SEVENTH STREET N.W., SUITE 600, WASHINGTON, DC, 20004, US

(21) Appl. No.: 11/664,258

(22) PCT Filed: Sep. 21, 2005
(86) PCT No.: PCT/EP05/10193

§ 371 Date: Mar. 30, 2007

(30) Foreign Application Priority Data
Sep. 30, 2004 (DE) 10 2004 047 593.8

(51) Int. Cl. G01N 21/64

(52) U.S. Cl. 436/172

(57) ABSTRACT

Disclosed is a reference member for fluorescence measurements, comprising a fluorescent layer (2) by means of which fluorescent radiation is emitted during optical irradiation and at least two fields that are provided with one respective attenuating layer (17 to 29). Said attenuating layer (17 to 29) is located above and/or underneath the fluorescent layer (2) and is partially transparent to the fluorescent radiation emitted by the fluorescent layer (2). The transmission factors of the attenuating layers (17 to 29) in the fields are different from each other.

The present invention relates to a reference member for fluorescence measurements and a method for the production thereof.

Fluorescence and luminescence measurements may be used to determine in a sample the presence of fluorescing or luminescing substances in a substance and, in particular, also the amount of these substances in the examined spatial region of the sample. A typical application of such fluorescence measurements is the examination of biological or biochemical samples, where, for example substances with fluorophores, which couple only with specific target molecules, are introduced into samples. Upon removal of the non-bonded fluorophores, the samples thus prepared may be examined by means of suitable fluorescence measuring devices, in particular so-called biochip readers. The detected fluorescent radiation gives information about the presence of target molecules with the fluorophores bonded thereto and ideally also about the concentration of the target molecules.

In order to obtain quantitatively reliable results it is necessary to obtain information about the detection capacity of the fluorescence or luminescence measuring devices that are used. Not only the purely optical imaging properties of such measuring devices, for example the resolving capability, but also the sensitivity of the measuring devices to the fluorescent radiation that is used, the linearity, i.e. in more precise terms the linearity of the dependence of the magnitude of the detection signals on the intensity of the fluorescent radiation intensity, and the dynamics of the measuring devices that are used, i.e. the size of the range between the minimum and maximum detectable fluorescent radiation intensity, are very important.

To determine or test these properties, reference samples, which are also called fluorescence standards, may be used. These reference samples exhibit known fluorescence properties. That is, when irradiated with optical excitation radiation of a defined excitation intensity, they emit fluorescent radiation with defined spatial, spectral and/or intensity-related properties. If such reference samples are examined with a fluorescence or luminescence measuring device that is used, the sensitivity, linearity and the dynamics of the fluorescence or luminescence measuring device may be evaluated.

The properties of such reference samples are not supposed to change or are supposed to change only negligibly over time or also as a function of the number of measurements at the reference sample. However, such changes may easily occur, if the geometric shape of the reference sample changes or a significant change in the fluorescence properties occurs due to bleaching out, in particular, in the course of repeated use or storage.

In order to evaluate the optical imaging properties of a fluorescence measuring device, the U.S. Pat. No. 6,472,671 proposes the use of a calibration tool, which exhibits a thin layer of solid fluorophores on a solid non-transparent support plate. The support plate is partially covered with a structured, non-transparent mask. A pattern with fine structures is etched as far down as into the range of 0.5 μm, into the mask, which may be a thin metal layer. Since the layer with solid fluorophores exhibits a constant thickness, the described calibration tool is not suitable for examining the linearity and the dynamic range of a fluorescence measuring device.

The US 004/005243 A1 describes a support with a layer of fluorescing material, which may be structured for examining the imaging properties of a fluorescence measuring device, so that a mask is not necessary.

In order to examine the sensitivity, the linearity and/or the dynamic range of fluorescence measuring devices, there are reference samples or rather fluorescence standards of different types.

For example, flat cuvettes with a height of, for example, a few micrometers may be filled with a fluorophore solution as the reference samples. A variation of the fluorescent intensity, emitted by such a reference sample, is possible by varying the concentration of the fluorophore solution filled into the cuvettes. One drawback with such reference samples is that the fluorophores are usually not stable over a prolonged period of time and bleach out relatively rapidly upon irradiation. In addition, it is difficult to prepare in a repeatable manner cuvettes with a precisely defined height. However, the fluorescent intensity is a function of the height and/or the thickness of the liquid or rather fluorophore solution layer in the cuvette so that the fluorescent intensity cannot be defined very accurately.

As an alternative, it was proposed to coat the support layers with layers that contain fluorophores.

The U.S. Pat. No. 6,471,916 describes the use of substrates with regions of varying fluorophore concentration as the fluorescence standard. However, it is not stated how they may be produced.

One known possibility for producing such fluorescence standards is to put fluorophores, for example Cy3 or Cy5, into aqueous solution and to prepare a dilution series. The dissolved fluorophores are then applied drop by drop on suitable supports, for example, microscope slides, and then dried up. Assuming that the volume of drops used in this procedure and also the diameter of the dried up drops are constant, one obtains supports with a fluorophore coating thickness that is proportional to the fluorophore concentration in the liquid. In everyday practice, however, the volume and diameter of the drops vary widely so that the proportionality is no longer a given. In addition, in the course of drying up, the fluorophore coatings often become very non-homogeneous. Finally the fluorophores that are used, even if cooled, are often not stable over a long period of time and bleach out relatively rapidly.

As an alternative, fluorescence standards may be obtained by placing polymer layers that contain fluorophores on a support.

Therefore, the US 2004/005243 A1 describes a support, which is intended for calibration and on which a layer of a fluorescing material of constant or varying thickness is applied.

The DE 12 00 865 A1 discloses a device for referencing fluorescent signals and/or for calibrating fluorescence detection systems, which exhibit a support, which does not fluoresce in essence and on which fluorescing polymer layers, whose thickness and/or composition vary/varies to some degree, are applied in a number of defined areas.

The DE 201 04 445 U1 and DE 201 04 446 U1 describe a fluorescence standard, which is produced by applying a plastic dispersion, which contains a fluorophore and is then hardened, on a support.

However, reference samples with polymer fluorophore layers, which are applied on a support and which exhibit varying thicknesses and/or varying fluorophore concentrations, have the drawback that the fluorophores bleach out with frequent use. In addition, the calibration of biochip readers, which exhibit a very large dynamic range, requires reference samples, with which a fluorescent radiation may be produced that exhibits a very wide range of fluorescent intensity. However, the required variation in the amount of fluorophores in the examined regions and, thus, the fluorescent intensity cannot be obtained easily by varying the thickness of the fluorophore-containing layers and/or the fluorophore concentrations in such layers.

Therefore, the present invention is based on the problem of providing a reference sample for fluorescence measurements. When said reference sample is irradiated with a defined optical radiation, a fluorescent radiation of different fluorescent intensities can be produced so as to be repeatable. Moreover, the invention provides a method for the production of the reference sample.

The problem is solved with a reference member for fluorescence measurements comprising a fluorescent layer, by means of which fluorescent radiation can be emitted during optical irradiation, and at least two fields that are provided with one respective attenuating layer that is arranged above and/or below the fluorescent layer and is partially transparent to fluorescent radiation, emitted by the fluorescent layer. The transmission factors of the attenuating layers in the fields are different from each other.

Furthermore, the problem is solved with a method for producing an inventive reference member for fluorescence measurements. In this method a fluorescent layer is prepared that emits during optical irradiation a fluorescent radiation. Furthermore, in at least two different fields one respective attenuating layer, which is partially transparent to fluorescent radiation, emitted by the fluorescent layer, is produced so that the transmission factors of the attenuating layers in the different fields are different from each other. The attenuating layers are arranged above and/or below the fluorescent layer. Depending on the order of sequence and the type of layers, the attenuating layers may be produced prior to, at the same time as, or after the fluorescent layer.

The inventive method for testing and/or calibrating a fluorescence measuring device uses an inventive reference member. In this method the optical excitation radiation is radiated into the fluorescent layer, and corresponding fluorescent radiation, passing through the attenuating layers, is detected in a resolved manner according to fields.

Then if the transmission of the attenuating layers is known, during analysis of the measurement results the sensitivity, the linearity and the dynamic range of the fluorescence measuring device may be evaluated.

Therefore, according to the invention, the fluorescent intensities are varied chiefly by means of the attenuating layers, which exhibit different transmission factors. The transmission factor of the attenuating layers is preferably known and in particular preferably predetermined for interesting types of fluorescence measuring devices. The advantage lies in the fact that the fluorescent layer can be produced in a very simple way; and in particular there is no need for a variation in the thickness and/or the concentration of the fluorescing materials contained therein. Attenuating layers of different transmission factors can be produced simply and accurately over a wide range of different transmission factors so that a reference member that is inexpensive to produce is provided. With this reference member different fluorescent radiation intensities can be produced very accurately and over a wider range of intensities. The fluorescence excitation may be carried out in transmitted light or in incident light.

Basically the transmission of an attenuating layer may be chosen at random as long as it is at least partially transparent to the fluorescent radiation. That is, as long as the transmission is less than 1 and preferably greater than, for example, 10⁻⁶. To enable the testing or calibration of even biochip readers, the transmission of the attenuating layers of the reference members of the invention ranges preferably from 10⁻⁵ to 0.5.

Therefore, it is especially preferred that the ratio of the transmission of the attenuating layer exhibiting the largest transmission factor to the transmission of the attenuating layer exhibiting the smallest transmission factor is greater than 10⁴. Such a configuration enables a calibration over a correspondingly wide dynamic range.

Even though it suffices in principle that there are only two fields with attenuating layers exhibiting different transmission factors, a reference member, according to the invention, has preferably a plurality of (i.e. more than two) fields with attenuating layers that exhibit different transmission factors, since in this way it is also possible to check the linearity of a fluorescence measuring device.

In order to obtain an optimal distribution of fluorescent intensities, produced by means of the reference member, for the purpose of testing a wide dynamic range, the reference member, according to the invention, comprises preferably more than two attenuating layers, which are arranged above and/or below the fluorescent layer and are arranged in different fields. The transmissions of said attenuating layers are logarithmically decremented in relation to each other.

In principle, the attenuating layers in the individual fields may be made of the same or different materials. In addition, they may be connected together in the regions between the fields or may be separated by these regions.

In principle, the transmission factors of the attenuating layers may be adjusted in different ways. For example, the reflectivity of the attenuating layers is varied for the fluorescent radiation. Preferably, however, the reference member, according to the invention, provides that the attenuating layers absorb the fluorescent radiation emitted by the fluorescent layer. During production of the attenuating layer, the absorption of an attenuating layer is simpler to vary over a wide range than its reflectivity.

In order to vary the absorption, the material of the attenuating layer may be modified. However, in the inventive reference member, the layer thickness of at least two of the attenuating layers is preferably different. A variation of the transmission factor by varying the layer thickness of the attenuating layers, preferably with the use of the same material for the attenuating layers, has the advantage that the transmission factor depends exponentially on the thickness of the layer so that a wide transmission range can be covered by simply varying the layer thickness of the attenuating layers. In addition, layers of a defined thickness can be produced easily and accurately.

The layers may be produced with any method for layer production. In the inventive method, however, at least one of the attenuating layers is applied preferably by means of vapor deposition. In the reference member, according to the invention, at least one of the attenuating layers is preferably deposited by means of vapor deposition. Then, depending on the construction of the reference member, the attenuating layer may be applied on a support layer or on the fluorescent layer. With this method the layer thickness of the attenuating layers can be controlled with high accuracy.

In principle the material of the attenuating layers may be chosen so as to be different for each attenuating layer. However, in the reference member, according to the invention, at least one of the attenuating layers is preferably a metal layer. With respect to the optical properties, especially the absorption of optical radiation, and the production, for example by means of vapor deposition, metal layers are more advantageous than other materials, such as polymers. In principle, any metal may be used. Yet the preferred metal layer is a chromium layer or titanium layer, since chromium and titanium exhibit good adhesive properties on conventional support materials.

A reference member, according to the invention, may be constructed for use with transmitted light and/or incident light. During fluorescent measurements the sample is often irradiated with excitation light in incident illumination, for which reason reflective properties of the reference member are often undesired. Therefore, the attenuating layers are preferably antireflected on at least one side, preferably the side facing away from the fluorescent layer. Preferably their reflectivity is less than 10%, in particular preferably less than 4%.

Preferably the reference member, according to the invention, is essentially not transparent in one region between the fields. This means that the transmission in this region is preferably less than 10⁻⁶. This construction makes it possible to achieve a clear demarcation between the different fields.

In order to check the homogeneity of the sensitivity of a fluorescence measuring device in the lateral direction, i.e. transversely to the direction of the excitation or fluorescent radiation, the reference member, according to the invention, is preferably transparent in a region between at least two fields or along at least one of the fields.

In order to produce in a repeatable manner the fluorescent radiation, the reference member is preferably shape-stable. To this end, the reference member, according to the invention, may exhibit a shape-stable support layer. The support layer, the fluorescent layer and the attenuating layers may be constructed and arranged in different ways.

In the embodiment of the reference member, according to the invention, the fluorescent layer forms preferably a shape-stable support layer. The result is an especially simple construction. In particular, a layer made of glass with embedded “quantum dots,” i.e. fluorescing semiconductor nanoparticles, preferably made of cadmium sulfide, zinc selenide, cadmium telluride or mercury selenide, may be used as the support layer. It may be constructed preferably as a support plate.

According to another preferred embodiment of the reference member, according to the invention, the fluorescent layer is placed on a shape-stable, essentially non-fluorescing support layer. In particular, it may be applied directly on the support layer, which may be constructed in particular as a support plate. A suitable support material is glass, whereas, for example, a “quantum dot” containing polymer, such as PMMA, is centrifuged as the fluorescent layer onto the support. As an alternative it is also possible to cement the fluorescent layer on the support layer.

The attenuating layer may be disposed, on the one hand, on the fluorescent layer, disposed on the support layer. However, in the reference member, according to the invention, the non-fluorescing support layer of a preferred embodiment is transparent, and the attenuating layers are applied on said support layer. This configuration of the attenuating layers makes it possible during the production of the reference member to determine or to control its (preferably spectral) transmission factor. Therefore, in the method, according to the invention, the attenuating layers are preferably applied on a shape-stable, essentially non-fluorescing, transparent support layer; the transmissions of the attenuating layers are determined; and thereafter, the fluorescent layer is applied on the support layer. Here, too, the support layer forms preferably a support plate.

However, it is especially preferred that the attenuating layers are sandwiched between the support layer and the fluorescent layer. To this end, in the method according to the invention, the fluorescent layer is applied on the attenuating layer after the transmission of the attenuating layers has been determined. Thus, the fluorescent layer and the support layer protect the attenuating layers, which may not be very strong, against mechanical damage and other environmental influences. When this embodiment is used in incident light, the excitation light is radiated into the transparent support layer.

The intensity of the fluorescent radiation, emitted by the reference member during excitation with optical excitation radiation, depends not only on the layer thickness and the materials of the attenuating layers, but also on the properties of the fluorescent layer, in particular its layer thickness and the concentration of the fluorescing materials contained therein.

If the fluorescent radiation intensities, emitted by the reference member, are to be varied solely by means of the properties of the attenuating layers, then the fluorescent properties of the fluorescent layer are preferably homogeneous in directions parallel to the fluorescent layer. This can be achieved preferably by distributing in a homogeneous manner a fluorescing material or a plurality of fluorescing materials, which impart to the fluorescent layer their fluorescing properties, in the directions parallel to the fluorescent layer. The variation in the concentration of the fluorescing material or the fluorescing materials in directions parallel to the fluorescent layer, through which the fluorescent radiation is radiated onto the attenuating layers, i.e. parallel to their surface, is preferably less than 5%.

In principle, the concentration of fluorescing materials in the fluorescent layer may be chosen at random. Preferably the maximum possible concentration is chosen, at which no mutual extinction of the fluorescence occurs.

In order, on the one hand, to produce and manipulate in a simple way the reference member and, on the other hand, to provide the same fluorescent radiation intensity for the various fields with attenuating layers, the fluorescent layer in the inventive reference member has preferably the shape of a plane parallel plate.

In principle the thickness of the fluorescent layer may be chosen at random. However, the fluorescent layer is constructed preferably in such a manner that the fluorescence is emitted from an active layer that is less than 2 μm. Thus, the thickness of such a layer is less than the depth of focus of typical fluorescence measuring devices so that it may be imaged in its entirety and sharply defined.

In the case that the fluorescent layer does not constitute simultaneously a support layer, its thickness may be chosen so that it is preferably less than 10 μm, in particular less than 2 μm.

In principle, the fluorescing effect of the fluorescent layer in the reference member, according to the invention, may be achieved in any manner.

In a preferred embodiment of the reference member, according to the invention, the fluorescent layer contains at least one organic fluorophore. This makes it possible to select a fluorophore from the large number of available organic fluorophores that is suitable for the given application. In particular, fluorophores may be selected that are also used in the examination of biological samples.

It is especially preferred that the fluorophore be selected from the NileBlue group: Cy3, Cy5, Cy7, fluorescein and rhodamine.

In another preferred embodiment of the reference member, according to the invention, the fluorescent layer contains ions that have a fluorescing effect. These ions may be in particular ions of heavy metals and/or rare earths, preferably colored glass. Such fluorescent layers are noted for their especially high stability.

In another preferred embodiment of the reference member, according to the invention, the fluorescent layer contains quantum dots that have a fluorescing effect. These quantum dots may be fluorescing semiconductor nanoparticles made of cadmium sulfide, zinc selenide, cadmium selenide or mercury telluride. Such quantum dots are noted for their especially high fluorescence yield. Encapsulating the quantum dots in a matrix material of the fluorescent layer may prevent the quantum dots from oxidizing and bleaching out.

In principle, the fluorescent layer of a reference member, according to the invention, may be designed only for optical excitation radiation of a defined excitation wavelength and a corresponding fluorescence wavelength of the fluorescent radiation excited thereby. Optical radiation is defined here as infrared radiation, visible light and ultraviolet light. The aforementioned transmission of the attenuating layers is given at the corresponding, predetermined fluorescence wavelength. The transmission of metallic attenuating layers is usually a function of the radiation wavelength, a feature that is taken into consideration when using the reference member. In order to cover the largest possible wavelength range, for example from ultraviolet to near infrared range [NIR], the fluorescent layer in the reference member, according to the invention, contains preferably at least two different fluorescing materials. They exhibit preferably fluorescent spectrums that are different from each other.

The reference members, according to the invention, are suitable especially for calibrating biochip readers.

The invention is explained in detail below by way of examples with reference to the drawings.

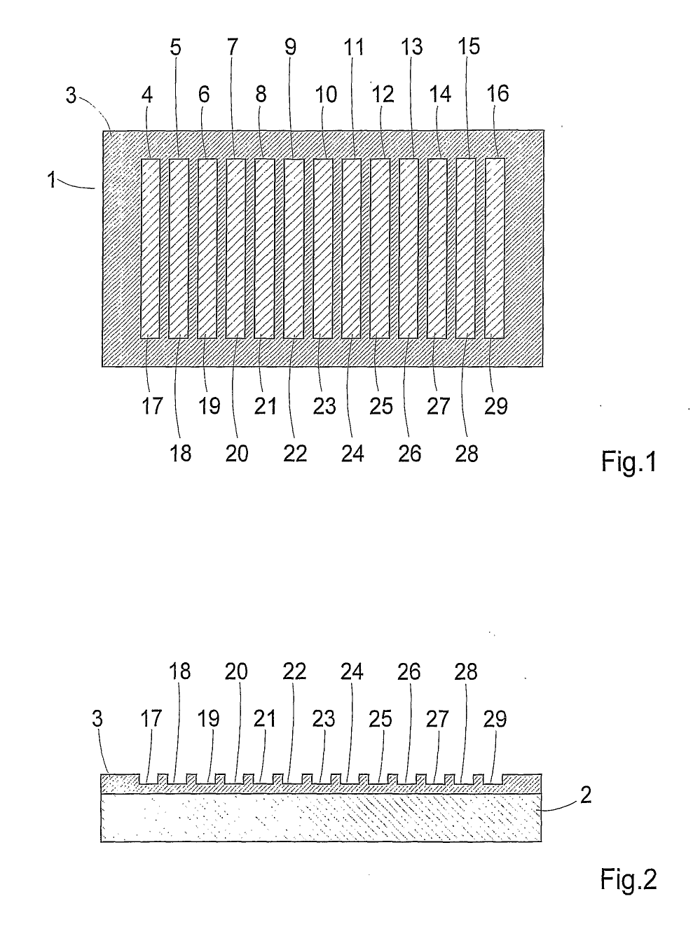

FIG. 1 is a top view of a schematic representation of a reference member for fluorescence measurements, according to a first preferred embodiment of the invention.

FIG. 2 is a lateral sectional view of a schematic representation of the reference member from FIG. 1.

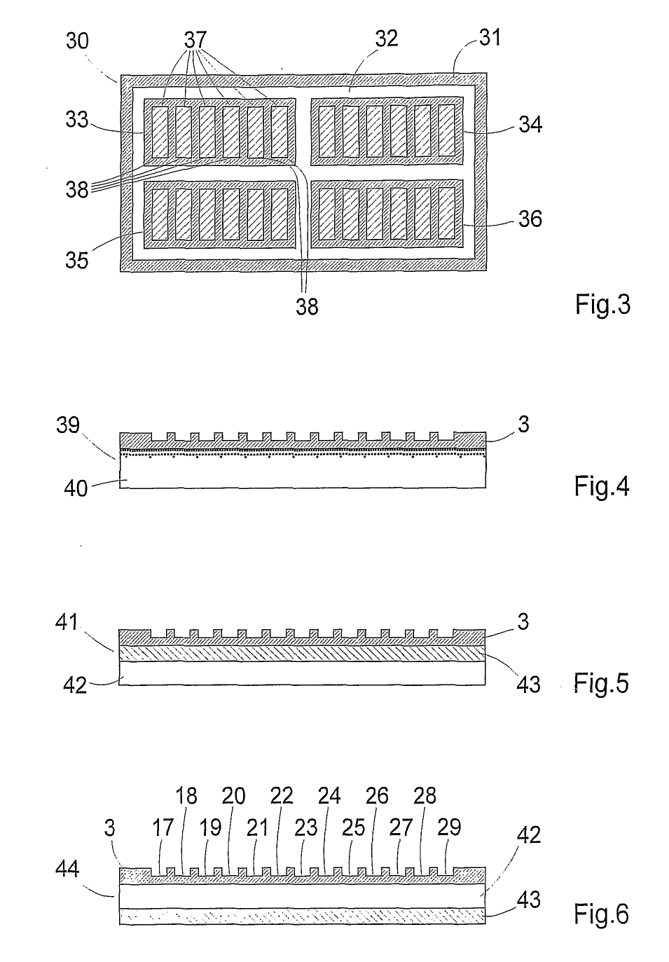

FIG. 3 is a top view of a schematic representation of a reference member, according to a second preferred embodiment of the invention.

FIG. 4 is a lateral sectional view of a schematic representation of a reference member, according to a third preferred embodiment of the invention.

FIG. 5 is a lateral sectional view of a schematic representation of a reference member, according to a fourth preferred embodiment of the invention.

FIG. 6 is a lateral sectional view of a schematic representation of a reference member, according to a fifth preferred embodiment of the invention.

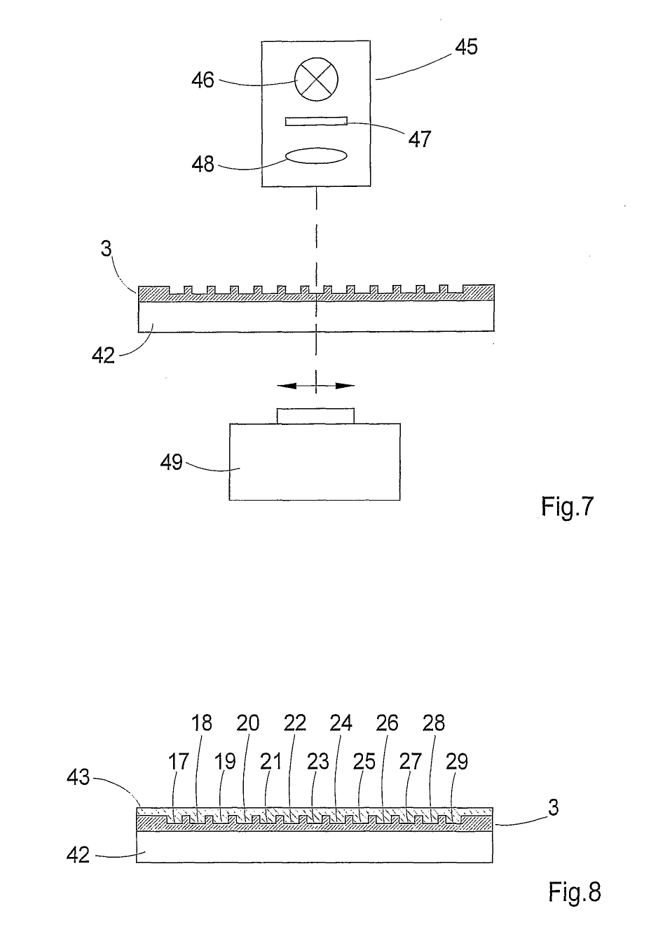

FIG. 7 is a schematic representation of a device for determining the transmission of fields with attenuating layers of the reference member from FIG. 6 during its production, and

FIG. 8 is a lateral sectional view of a schematic representation of a reference member, according to a sixth preferred embodiment of the invention.

In FIGS. 1 and 2 a reference member 1 for fluorescence measurements comprises a fluorescent layer 2, which serves as the shape-stable support layer, and a metal layer 3, which is disposed above said fluorescent layer and which is typically and especially in the example thinner than 1 μm.

The fluorescent layer 2 has the dimensions of a conventional specimen slide and in particular the shape of a plane parallel plate. It is made of glass with fluorescing materials embedded therein. In the example, colored glass is used that obtains its fluorescing properties from the ions of heavy metals and/or rare earths embedded therein. In another preferred embodiment quantum dots, instead of ions, may be embedded in the fluorescent layer. In yet another embodiment the fluorescent layer 2 may be supplied by a shape-stable, dyed-through plastic plate, which contains the corresponding fluorophores. The principal material of the fluorescent layer, i.e. the glass (or as an alternative plastic), is so highly absorbing to the fluorescent radiation that the fluorescent

radiation is emitted in essence only from a very thin layer of less than 10 micrometers thick.

The metal layer 3 exhibits fields 4 to 16, in which the thickness of the metal layer 3 is significantly reduced by varying amounts. Thus, the fields 4 to 16 have attenuating layers 17 to 29, whose thickness, starting from field 4, increases from field to field as far as up to field 16. At the same time the thickness of the metal layer 3 is chosen in such way that the transmission of the attenuating layers 17 to 29 assumes values ranging from 0.5 to 10⁻⁶ in a logarithmic decrement. The attenuating layers 17 to 29 in the fields 4 to 16 are separated from each other by the remaining regions of the metal layer 3. Said regions exhibit a transmission of less than 10⁻⁶ and must, therefore, be regarded as non-transparent. Hence, the fluorescent radiation from one of the attenuating layers does not penetrate into the region of the neighboring field.

The outer surface of the metal layer 3 is antireflected up to a residual reflectivity of 4%, so that a reflectivity that is comparable to conventional specimen slides is obtained. This is useful for autofocusing devices.

The reference member 1 can be produced in a simple way by producing the fluorescent layer 2 in a first step. Then this layer is coated by vapor deposition with a corresponding metal, for example chromium. The predetermined height profile, shown in FIG. 2, is produced with the use of suitable masks. For the sake of a better overview FIG. 2 shows the predetermined layer thicknesses, in particular also those of the attenuating layers, as disproportionally thick.

When the reference member 1 is used, it is put in incident light under a fluorescence measuring device, for example a fluorescence microscope. Then optical excitation radiation is radiated onto the reference member 1. Said excitation radiation penetrates the metal layer 3 and in particular also the attenuating layers 17 to 29, thus attenuating, and excites the emission of fluorescent radiation in the fluorescent layer 2. Then the fluorescent radiation in the direction of the metal layer 3 may be emitted through the attenuating layers 17 to 29 into the fields 4 to 16, thus weakening as a function of the transmission of the attenuating layers 17 to 29. Therefore, based on the intensity of the excitation radiation, the detectable intensity or rather the corresponding measurement signals are attenuated twice owing to the attenuating layers 17 to 29. Then the fluorescent radiation, emitted through the attenuating layer 17 to 29, is detected with spatial resolution by the fluorescence microscope so that for each of the fields 4 to 16 the corresponding detection signals, rendering the intensity of the fluorescent radiation passing through the corresponding attenuating layers, are recorded. By analyzing these detection signals at the known transmissivity of the attenuating layers 17 to 29, the sensitivity, the linearity and the dynamic range of the fluorescence measuring device, here the fluorescence microscope, may be determined in a simple way.

FIG. 3 is a top view of a schematic representation of a reference member 30, according to a second preferred embodiment of the invention. The distinction between said reference member and the reference member 1 of the first embodiment lies in the structure of the metal layer. The other layers are unchanged compared to those of the first embodiment so that the same reference numerals are used for them; and the explanations thereto also apply correspondingly here.

The metal layer is structured as follows. Four non-transparent regions 33 to 36 are disposed in an outer frame 31 so that these regions are separated from each other and from the frame 31 by means of a transparent pattern 32. In these regions there are in turn six fields 37 with attenuating layers 38 of varying attenuating layer thickness and, thus, with varying transmission.

The frame 31 and the regions 33 to 36 without the fields 37 and/or the attenuating layers 38 exhibit a transmission of less than 10⁻⁶ and are, therefore, for all practical purposes not transparent.

The layer thickness of the attenuating layers 38 in the fields 37 increases (from top left to bottom right in FIG. 3) from field to field so that a logarithmic decrement of the transmissions is obtained. The thickness of the attenuating layers is chosen in such a manner that the same transmission range is covered as in the first embodiment. The result of the larger number of fields 37 or rather the attenuating layers 38 with varying transmission factors is in essence a finer logarithmic decrement of the fluorescent intensities than in the first embodiment. The top side of the metal layer is, as in the first embodiment, antireflected up to a residual reflectivity of 4% so that a reflectivity, comparable to that of conventional glass slides, is achieved. This feature is useful for autofocusing devices.

The transparent region 32, in which there is no metal layer, makes it possible to test the homogeneity of the fluorescent sensitivity of the fluorescence measuring device in the lateral direction, i.e. in the direction of the plane of the plate-shaped reference member 30.

FIG. 4 is a lateral sectional view of a schematic representation of a reference member 39, according to a third preferred embodiment of the invention. The distinction between said reference member and reference member 1 of the first embodiment lies in the fact that the fluorescent layer 2 is replaced with a support layer 40, into which (as viewed from the top in FIG. 4) fluorescing material is introduced, for example by ion implantation. Therefore the concentration of these materials decreases as the distance from the surface of the support layer 40 facing the metal layer 3 increases. At the same time the concentration of the fluorescing materials is chosen in such a way that the actively fluorescing layer is less than 10 μm thick. The other layers are unchanged compared to those of the first embodiment so that the same reference numerals are used for them and the explanations for them also apply correspondingly here.

FIG. 5 is a lateral sectional view of a schematic representation of a reference member 41, according to a fourth preferred embodiment of the invention. The distinction between said reference member and reference member 1 of the first embodiment and/or the reference member 39 of the third embodiment lies in the fact that, instead of the fluorescent layer 2 or respectively the support layer 40, a shape-stable, non-fluorescing, transparent, plane parallel plate 42, made, for example of glass, is used as the support layer, on which a thin, fluorescing plate 43 of constant thickness is cemented. The transparent plate 42 is coated by means of vapor deposition with a metal layer with fields with attenuating layers. Since said metal layer is analogous to the metal layer 3 of the first embodiment, it bears the same reference numeral.

The fluorescing plate 43 contains a mixture of fluorescing materials (in the example organic fluorophores) so that through excitation with suitable optical radiation, fluorescent radiation may be produced in the individual bands in the wavelength range between the ultraviolet and NIR range.

FIG. 6 is a lateral sectional view of a schematic representation of a reference member 44, according to a fifth preferred embodiment of the invention. The distinction between said reference member and reference member 41 of the fourth embodiment lies in the fact that the fluorescent layer or respectively the fluorescing plate 43 is arranged on a different side of the support layer 42 than the metal layer 3, which is applied by means of vapor deposition directly on the support layer 42.

In a first step during production the support layer 42 is coated with the metal layer 3 by means of vapor deposition. In a next step the spectral transmission of the attenuating layers 17 to 29 in the fields 4 to 16 is determined with the device, which is depicted in FIG. 7 as a crude schematic representation. This device has an illuminating unit 45 with a light source 46, a spectral filter 47 for filtering the light emitted by the light source 46, and collimating optics 48 for bundling the light passing through the spectral filter 47, and a transmission detector 49 and/or a spectrometer. By moving the transparent support 42 with the metal layer 3 thereon transversely to the direction of the light of the illuminating unit 45, the transmission of the metal layer 3 may be recorded with spectral spatial resolution.

After determining the transmission of the attenuating layers 17 to 29 in the fields 4 to 16, the transparent fluorescing plate 43 is cemented with the support layer 42.

The result is a reference member, for which the exact transmission factor of the attenuating layers is known and which, therefore, enables a very exact calibration.

FIG. 8 is a schematic representation of a reference member, according to a sixth preferred embodiment of the invention. The distinction between said reference member and the reference member of the fifth embodiment lies only in the order of sequence of the layers, so that the same reference numerals are used.

The fluorescent layer 43, which exhibits a thickness of about 2 μm in the example, is now not placed directly on the support layer and/or the support plate 42, but rather on the metal layer 3, where the fields have attenuating layers of varying transmission factors. Thus, the metal layer 3 and in particular the attenuating layers 17 to 29 are shielded from environmental influences.

The reference member is produced as in the preceding embodiment. However, now the fluorescent layer 43 (made of a polymer with embedded quantum dots in the example) is centrifuged on the metal layer 3 and, thus, the attenuating layers 17 to 29, after their transmission factor was determined.

### LIST OF REFERENCE NUMERALS

1 reference member
2 fluorescent layer
3 metal layer
4, . . . , 16 fields
17, . . . 29 attenuating layer
30 reference member
31 frame
32 patterned region
33, . . . , 36 transparent region
37 field
38 attenuating layer
39 reference member
40 support layer
41 reference member
42 support layer
43 fluorescent layer
44 reference member
45 illuminating unit
45 light source
47 spectral filter
48 collimating optics
49 transmission detector

1. Reference member for fluorescence measurements, the reference member comprising:
a fluorescent layer, by means of which fluorescent radiation can be emitted during optical irradiation, and
at least two fields that are provided with one respective attenuating layer, which is arranged above and/or below the fluorescent layer and which is partially transparent to the fluorescent radiation emitted by the fluorescent layer, where the transmission factors of the attenuating layers in the fields are different from each other.

2. Reference member, as claimed in claim 1, wherein transmission of the attenuating layers ranges from 10⁻⁵ to 0.5.

3. Reference member, as claimed in claim 1, wherein the ratio of the transmission of the attenuating layer exhibiting the largest transmission factor to the transmission of the attenuating layer exhibiting the smallest transmission factor is greater than 10⁴.

4. Reference member, as claimed in claim 1, wherein more than two attenuating layers, which are arranged in different fields, are arranged above and/or below the fluorescent layer, whose transmissions are logarithmically decremented in relation to each other.

5. Reference member, as claimed in claim 1, wherein the attenuating layers absorb the fluorescent radiation emitted by the fluorescent layer.

6. Reference member, as claimed in claim 1, wherein the layer thickness of at least two of the attenuating layers is different.

7. Reference member, as claimed in claim 1, wherein at least one of the attenuating layers is applied by means of vapor deposition.

8. Reference member, as claimed in claim 1, wherein at least one of the attenuating layers is a metal layer.

9. Reference member, as claimed in claim 1, wherein the attenuating layers are antireflected on at least one side.

10. Reference member, as claimed in claim 1, wherein one region between the field is essentially not transparent.

11. Reference member, as claimed in claim 1, wherein one region between at least two fields or along at least one of the fields is transparent.

12. Reference member, as claimed in claim 1, wherein the fluorescent layer is a shape-stable support layer.

13. Reference member, as claimed in claim 1, wherein the fluorescent layer is disposed on a shape-stable, essentially non-fluorescing support layer.

14. Reference member, as claimed in claim 13, wherein the non-fluorescing support layer is transparent; and the attenuating layers are applied on said support layer.

15. Reference member, as claimed in claim 1, wherein the fluorescent properties of the fluorescent layer are homogeneous in directions parallel to the fluorescent layer.

16. Reference member, as claimed in claim 1, wherein the fluorescent layer has the shape of a plane parallel plate.

17. Reference member, as claimed in claim 1, wherein the fluorescent layer is constructed in such a manner that the fluorescence is emitted from an active layer that is less than 2 μm.

18. Reference member, as claimed in claim 1, wherein the fluorescent layer contains at least one organic fluorophore.

19. Reference member, as claimed in claim 1, wherein the fluorescent layer contains ions that have a fluorescing effect.

20. Reference member, as claimed in claim 1, wherein the fluorescent layer contains quantum-dots that have a fluorescing effect.

21. Reference member, as claimed in claim 1, wherein the fluorescent layer contains at least two different fluorescing materials.

22. Method for producing a reference member for fluorescence measurements, where a fluorescent layer is produced, by means of which fluorescent radiation can be emitted during optical irradiation and, in at least two different fields one respectively attenuating layer is produced that is partially transparent to the fluorescent radiation emitted by the fluorescent layer, so that the transmission factors of the attenuating layers in the different fields are different from each other, whereby the attenuating layers are arranged above and/or below the fluorescent layer.

23. Method, as claimed in claim 22, wherein at least one of the attenuating layers is applied by means of vapor deposition.

24. Method, as claimed in claim 22, wherein the attenuating layers are applied on a shape-stable, essentially non-fluorescing, transparent support layer, the transmissions of the attenuating layers are determined, and thereafter the fluorescent layer is applied on the support layer.
